(19) United States
(12) Patent Application Publication
(10) Pub. No.: US 2019/0133164 A1
(43) Pub. Date: May 9, 2019

(54) PROTEIN DRINK AND METHOD FOR PRODUCING SAME

(71) Applicant: Peter KLASSEN, Temmels (DE)

(72) Inventors: Peter KLASSEN, Temmels (DE); Philipp KLASSEN, Temmels (DE); Stefan KIMMEL, Irsch (DE)

(73) Assignee: Peter KLASSEN, Temmels (DE)

(21) Appl. No.: 16/094,170

(22) PCT Filed: Apr. 16, 2017
(86) PCT No.: PCT/DE2017/000103

§ 371 Date: Oct. 16, 2018

(30) Foreign Application Priority Data
Apr. 16, 2016 (DE) 10 2016 107 075.0

(51) Int. Cl. A23L 13/60; A23L 2/66

(52) U.S. Cl. CPC A23L 13/60; A23L 23/00; A23L 2/66

(57) ABSTRACT

The invention relates to a protein drink comprising, each with regard to the total weight of the drink, 3 to 20% by weight proteins, 0.5 to 5% by weight fat, 70 to 95% by weight water and 0.5 to 15% by weight carbohydrates, of which 0.5 to 10% by weight is sugar.

According to the invention, the protein drink consists of 80-100% by weight of meat broth. It is produced by the production steps: grinding meat, producing a meat broth, bringing the meat broth containing all the ground meat to the boil, finely pureeing, pouring the protein drink into bottles or cans and sterilising the protein drink.

The present invention relates to a protein drink according to the preamble of claim 1, in particular based on meat broth, and a method and a use of an industrial mixer for its production with features of claim 8 or 12, as known in part from GB 1 490 144 A or WO 2013/004 778 A1.

### BACKGROUND OF THE INVENTION

Proteins are biological macromolecules constructed out of amino acids, which are found in all cells of the human body. Thus, a human being's muscles, brain, skin and hair largely consist of proteins. The proteins in the human organism have very different functions, such as antibodies to combat infections, as collagens to strengthen the skin, the connective tissue and the bones, as enzymes during metabolism or even as reserve substances for providing energy. Lack of protein leads to hair loss, muscle weakness, growth disorders or fatty liver. Important foods as sources of protein for a human being are eggs, fish, meat, legumes, dairy products and nuts.

The advantage of meat as a basis for the daily protein requirement consists in the fact that, besides protein, meat also contains fat, vitamins and minerals which can act as an additional source of energy for the body and for strengthening the immune system. Thus, for example, 100 g of beef contains approx. 20 g to approx. 30 g of protein and approx. 2 g to approx. 15 g of fat, wherein the remaining content substantially comprises water. However, small yet effective quantities of minerals are also present, wherein, above all, sodium, potassium, magnesium, calcium, iron and phosphorus. Furthermore, meat contains vitamins such as vitamin A1 (retinol), vitamin B1, (thiamine), vitamin B2 (riboflavin), vitamin B6 (pyridoxine), vitamin C (ascorbic acid) and vitamin B3 (niacin).

Thus, a well-seasoned beef broth has not only a superb taste but also numerous advantages for the consumer's health. Therefore, beef bone broth, for example, has recently developed into a fashionable food sold in a paper cup with a plastic lid to take out and drink on the move, wherein the broth supposedly provides strength and energy, strengthens the immune system and supplies important building blocks for the connective tissue and the joints.

Not only beef broths but also chicken broths in particular are especially popular with consumers.

### PRIOR ART

Drinks containing protein are described in WO 2007/118610 A1, for example. The subject matter of this patent application is a functional drink containing carbohydrates, which comprises at least one protein hydrolysate dissolved in a liquid medium and at least one sucrose isomer selected from the leucrose and isomaltulose group.

Described in DE 600 24 438 T2 is a sports drink which comprises micronutrients in combination with conventional supplements, wherein the micronutrients are selected from the group consisting of ascorbic acid, vitamin E, beta-carotene, pyridoxine, riboflavin, thiamine, niacin, cobalamin, folic acid, Q10, copper, magnesium, manganese, selenium, zinc and chromium. In combination with viable lactobacilli, the micronutrients are supposed to have a positive effect on the human intestinal mucosa.

DE 101 05 689 A1 describes an instant powder which is used to produce an instant drink containing protein, in order to compensate for a low-meat or meat-free diet, wherein the instant powder contains particularly preferably soya proteins in a quantity ranging from 80 to 92% by weight with regard to the weight of the instant powder.

Documents GB 1 490 144 A and WO 2013/004 778 A1 are also cited.

A disadvantage of the protein drinks according to the prior art consists in particular in that they mostly having an artificial taste, so that the consumer associates their consumption with only negligible pleasure. In addition, the protein drinks according to the prior art are largely composed of artificial ingredients and often lack trace elements that are important for the body, which are present in natural sources of protein like meat, bones and bone marrow.

### OBJECT TO BE ACHIEVED AND DESCRIPTION OF THE INVENTION

The object of the present invention now consists in selling a protein drink with a relatively long sell-by date, which has the superb taste of a genuine broth and is suitable as a food supplement, as a power drink for in-between meals or also as a sports drink for restoring expended energy to the body. The object is achieved by a protein drink according to claim 1, comprising its characterising features or a method and a use of an industrial mixer to produce the protein drink according to claim 8 or 12, comprising all the method features.

Advantageous embodiments are the subject matter of respective sub-claims.

The protein drink comprises 3 to 20% by weight proteins, 0.5 to 5% by weight fat, 70 to 95% by weight water and 0.5 to 15% by weight carbohydrates, of which 0.5 to 10% by weight is sugar. The respective weight proportions refer to the total weight of the protein drink. In line with the concept of an innovative production of a meat drink, added meat with all its ingredients is fully preserved in the finished drink.

In addition, the protein drink according to the invention advantageously additionally contains vitamins and mineral substances, wherein the vitamins are selected from the group consisting of vitamin A1 (retinol), vitamin B1 (thiamine), vitamin B2 (riboflavin), vitamin B6 (pyridoxine), vitamin C (ascorbic acid) and vitamin B3 (niacin) and the mineral substances are selected in particular from the group consisting of sodium, potassium, magnesium, calcium, iron and phosphorus.

Meat broth serves as the primary source of protein, 80 to 100% by weight of the protein drink being based on meat broth. Additional proteins to enrich the protein drink are advantageously added in the form of soya protein isolate, wherein the addition is preferably in the form of powder.

Moreover, in a preferred embodiment of the present invention, carbohydrates in the form of maltodextrin, inulin, skimmed milk powder and guar gum are each likewise added to the protein drink as a powder.

To improve the taste, the protein drink according to the invention preferably contains honey, cocoa powder and, advantageously, at least one flavouring agent. The honey acts as a source of energy and to sweeten the protein drink. The cocoa powder provides not only the flavouring but also fat and proteins. A preferred flavouring agent is almond flavouring, wherein merely a few drops of almond flavouring are sufficient to give the protein drink the desired taste.

The method for producing a protein drink comprises the successive and, possibly, sequentially overlapping method steps:
Grinding cooled or defrosted meat by means of a meat mincer,
Producing a meat broth made out of the ground meat, possibly after adding liquid, at any rate without removing fine particles or the like,
Bringing the meat broth to the boil,
Finely pureeing the broth containing all of the added ground meat by means of an industrial mixer or the like,
Pouring the protein drink containing the added ground meat entirely into bottles and cans, and
Sterilising the protein drink over 115° C., preferably at a temperature of 121 C°.

This method enables the successful production of meat drinks of which up to a third of the total weight of the drink is entirely meat, wherein sufficient liquefaction is achieved in accordance with the method according to the invention for the meat drink to be drinkable, and even, given a special method, conveyable through feeding tubes. Particularly preferred is the use of an industrial mixer to produce the drink after the pre-ground meat has been boiled in its broth until tender.

According to an advantageous embodiment of the production method, the broth is mixed among bones with a base powder which comprises carbohydrates, proteins and ascorbic acid. Particularly preferred is an addition of honey, cocoa powder and/or flavouring agent.

Beef broth is preferably used as a meat broth. However, other meat broths, in particular chicken broths, are also very suitable for the production of the protein drink according to the invention.

An embodiment for producing the protein drink is explained in more detail below, using the example of a beef broth.

To produce the beef broth, between 2 kg and 5 kg of beef, in particular ox neck, are ground in the meat mincer and boiled for approx. 1 hour in approx. 10 litres of water together with beef bones, in particular marrow bones, and soup herbs and/or soup vegetables, such as bay leaves, rosemary, sage, thyme, lovage, parsley, leeks, celery, garlic, onions and juniper berries, and simmered at boiling temperature for a further 3 hours to achieve an optimum leaching of the contents and prevent a separation of the fat from the mixture. The whole is then seasoned with salt and pepper or other spices, such as coriander and nutmeg. The seasoning with salt can also preferably follow the boiling, which benefits the osmotic processes for releasing the minerals from the bones. Naturally, dried soup herbs can also be used as well as or instead of fresh soup herbs.

Finally, according to an advantageous version of the method, the broth can be roughly passed through a sieve, the remaining solid portions pressed out, very finely puréed separately and then re-added, the fat then removed from the broth, the broth passed through a sieve to remove undesired solid and cloudy substances, then very finely puréed once more and re-added. Alternatively, the following procedure was carried out to obtain a good drink: after the boiling process the fat is removed from the broth in order to remove undesired solid and cloudy substances. The broth and all its solid portions can now be ground in order to derive a drink that is potable.

Five litres of the broth of the type thus obtained are brought to the boil in a fresh pot, mixed while boiling with approx. 100 g to approx. 350 g of a base powder which comprises not only carbohydrates (polysaccharides), proteins and ascorbic acid, but also lecithin. The mixture is boiled long enough for a stable emulsion to form. The emulsion is finally mixed with liquid honey, cocoa powder and almond flavouring by means of stirring. The finished protein drink can now be poured into bottles and preferably sterilised at 121 C°.

In this case, mean nutritional values per 100 g were established in the analysis: calorific value 262 kJ/62 kcal, fat 3.6 g, of which saturated fatty acids 1.4 g, carbohydrates 4.0 g, of which sugar 4.0 g, protein 3.5 g and salt 0.2 g.

In a preferred embodiment of the present invention the base powder consists of maltodextrin, inulin, soya lecithin, soya protein isolate, skimmed milk powder, guar gum and ascorbic acid. The quantities of the individual ingredients can be varied within a relatively wide scope and substantially depend on how much of which proteins or carbohydrates the finished protein drink should contain. It was found that an advantageous base powder has a proportion of 30-55% by weight proteins, 20 to 40% by weight carbohydrates, 5 to 20% by weight polysaccharides, 5 to 20% by weight lactose, 5 to 20% by weight lecithin and 0.5 to 5% by weight ascorbic acid.

The quantities of liquid honey and cocoa powder used can also vary and depend on the desired taste of the protein drink. Approx. 50 to 300 g of liquid honey and 10 to 60 g of pure cocoa powder are advantageously used for 5 litres of broth. A preferred flavouring agent, which should round off the taste of the protein drink, is roasted almond flavouring, which is used in only a few millilitres, wherein the quantity used here also again depends on the desired taste.

The example presented above must not be regarded as a limitation. Rather, it can be borne in mind that other types of meat are also suitable for producing the starting broth for the protein drink, in particular meat from poultry, but also veal and other types. Furthermore, the production of the starting broth offers numerous possible ways of affecting the taste of the broth, by adding different spices, soup herbs and soup vegetables. Thus, soup vegetables, for example, can also be roasted with bones before being added to the broth, in order to intensify the taste.

In addition, the proportions of carbohydrates and proteins can be varied by means of the quantity and variation of the base powder added, and adapted to the respective intended purpose. Not least, the substances which give the flavour, such as cocoa powder, honey and the pure flavouring agents, can naturally also be varied in terms of quantity or replaced by other substances, whereby the taste of the protein drink can be altered according to the wishes of the consumer.

What is claimed is:

1. A protein drink comprising, with regard to the total weight of the drink respectively, 3 to 20% by weight proteins, 0.5 to 5% by weight fat, 70 to 95% by weight water and 0.5 to 15% by weight carbohydrates, of which 0.5 to 10% by weight is sugar, characterised in that the protein drink consists 80-100% by weight of meat broth, wherein added ground meat is fully preserved in the protein drink.

2. The protein drink according to claim 1, characterised in that the protein drink comprises vitamins and mineral substances, wherein the vitamins are selected from the group consisting of vitamin A (retinol), vitamin B1 (thiamine), vitamin B2 (riboflavin), vitamin B6 (pyridoxine), vitamin C (ascorbic acid) and vitamin B3 (niacin) and wherein the mineral substances are selected from the group consisting of sodium, potassium, magnesium, calcium, iron and phosphorus.

3. (canceled)

4. The protein drink according to claim 1, characterised in that the protein drink comprises maltodextrin, inulin, skimmed milk powder and guar gum as sources of carbohydrates.

5. (canceled)

6. The protein drink according to claim 1, characterised in that the protein drink comprises honey as a source of sugar.

7. (canceled)

8. A method for producing a protein drink, wherein the method comprises:
Grinding cooled or defrosted meat by means of a meat mincer or another pureeing device,
Producing a meat broth made out of the ground meat, possibly optionally after adding liquid, at any rate without removing fine particles or the like,
Bringing the meat broth to the boil,
Finely pureeing the broth containing all of the added ground meat,
Pouring the protein drink containing the added ground meat entirely into bottles or cans, and
Sterilising the protein drink.

9. The method according to claim 8, characterised in that bringing the meat broth to the boil is followed by: mixing the broth among bones with a base powder which comprises carbohydrates, proteins, lecithin and ascorbic acid, adding honey, cocoa powder and flavouring agent.

10. The method according to claim 8, characterised in that beef is used to produce the meat broth, wherein the beef is first ground in the meat mincer, seasoned with salt and pepper and brought to the boil in water with soup herbs, and kept at boiling temperature for approximately 3 hours in order to achieve an optimum leaching of the ingredients and to prevent a separation of the fat, whereupon the fine pureeing follows.

11. The method according to claim 8, characterised in that the meat broth with the finely ground meat is boiled until the meat has become tender, and in that it is then puréed until an ability to move through feeding tubes is achieved.

12. The method according to claim 8, wherein the finely pureeing is conducted in an industrial mixer to purée meat broth which contains finely ground meat cooked until tender.

13. The method according to claim 8, wherein ox neck is used to produce the meat broth, wherein the ox neck is first ground in the meat mincer, seasoned with salt and pepper and brought to the boil in water with soup herbs, and kept at boiling temperature for approximately 3 hours in order to achieve an optimum leaching of the ingredients and to prevent a separation of the fat, whereupon the fine pureeing follows.

14. The method according to claim 8, wherein at least two of the steps sequentially overlap.
